(19) United States
(12) Patent Application Publication
(10) Pub. No.: US 2001/0045756 A1
(43) Pub. Date: Nov. 29, 2001

(54) Safety measures for lifting slings

(76) Inventor: Lars Fredriksson, Akersberga (SE)

Correspondence Address: J. Rodman Steele, Jr., Akerman, Senterfitt & Eidson, P.A., Post Office Box 3188, West Palm Beach, FL, 33402-3188, US

(21) Appl. No.: 09/811,154

(22) Filed: Mar. 16, 2001

(30) Foreign Application Priority Data
Mar. 16, 2000 (SE) 0000869-8

(51) Int. Cl. B66C 1/12

(52) U.S. Cl. 294/74

(57) ABSTRACT

A method of providing a safety measure when lifting a load (13) by means of a lifting sling (10) with at least two legs (10a, 10b) connected to the load (13) at two connection points (14a, 14b). Instead of checking the inclinational angle of each sling leg, in addition to observing the working load limit (WLL), the user can check that the horizontal distance between the connection points does not exceed a Horizontal Length Limit (HLL).

### FIELD OF THE INVENTION

The present invention relates to safety measures for lifting slings, including a safety method, a lifting sling and a safety tag to be attached to such lifting slings.

### BACKGROUND OF THE INVENTION

### Prior Art

Lifting slings for connecting a lifting device, such as a crane hook, to a load to be lifted are well-known. Such slings are generally constituted by chains, wire ropes or synthetic fiber. Normally, the slings have two, three or four legs of equal length, which are joined together at their upper ends and are coupled to a common, elongated master link assembly, the master link being dimensioned so that it can be hung into the gap of a crane hook.

Each leg of the sling is normally equipped with a terminal attachment fitting, e.g. a hook, an end link or a shackle, for safe connection to the actual load. Alternatively, the lifting sling may be formed as a loop dimensioned to extend around and underneath the load during lifting. Such a loop can be endless, in which case it is directly hung into the crane hook or the like, or it can be connected to a master link assembly at the upper end portions of each leg, which extend between the respective upper end points and the two connection points making mechanical contact with the load during lifting.

For a long time, there has been an established practice that each sling leg, including any fittings at the upper and/or the lower ends of the legs, can be loaded up to a maximum static force for a particular type of sling, e.g. for a specific type of lifting chain (dimension, material quality grade, etc.). This maximum load is the rated Working Load Limit (WLL) for a lifting sling with only one leg (hanging down vertically during lifting).

For multileg slings, this maximum load or WLL is converted to another value for the whole sling. The converted value will depend on the number of legs and the inclinational angle to the vertical (hereinafter called the “angle to vertical”) for the legs.

The larger the angle to vertical is, the lower the WLL will be. For safe use, it is normally required that the sling has an attached sling tag marked with the particular WLL for the sling. A common practice has been established, whereby the WLL is rated at the angles of 45 degrees and 60 degrees to the vertical, always under the assumption that the load is symmetrical and equally distributed to the separate legs, i.e. that the angle to vertical is the same for each leg of the sling.

Specific Working Load Limits (WLL) for single chain slings, two-leg chain slings, three- and four-leg chain slings, and endless chain slings (loops) are given in the European Norm EN 818-5:1999 for angles up to 45 degrees and angles between 45 and 60 degrees, respectively. This document also includes examples of Identification tags for such chain slings (Annex D).

However, it has been experienced on the jobsites that it is very difficult to accurately measure the actual angle to vertical. Also, the measuring procedure has to be repeated for every load to be lifted.

If the Working Load Limit (WLL) of a one-leg sling is 1 ton (t), then the corresponding values for a two-leg sling can be easily calculated as follows (corresponding values can of course be calculated also for slings with three or four legs):

| Angle to vertical (degrees) | WLL, two-leg sling(tons) |
|---|---|
| 45 | 1.414 |
| 50 | 1.286 |
| 60 | 1.000 |
| 65 | 0.845 |

As indicated above, the sling tags will indicate the rated values for 45 and 60 degrees. Accordingly, in case the actual angle is 50 degrees instead of 45 degrees, this measuring error of only 5 degrees will result in an overload on the sling legs of 1,414/1,286-1 which is approximately 10%. On the other hand, if the actual angle is 65 degrees instead of 60 degrees, this measuring error, likewise of only 5 degrees, will result in an overload of 1.000/0.845-1 which is approximately 18%.

Therefore, the measuring errors of the angle to vertical for slings in practical service will either result in overloads up to about 20% or even more, or make it necessary to derate the lifting capacity of the particular lifting sling so as to avoid such overloads.

### OBJECT OF THE INVENTION

The main object of the present invention is to achieve an improved and more accurate method for providing an acceptable safety measure when lifting a load by means of a lifting sling coupled to a lifting device as discussed above.

It is also an object of the invention to provide a simple practical means for implementing such an improved method.

### SUMMARY OF THE INVENTION

The above-mentioned main object is achieved by introducing the concept of a horisontal length limit (HLL), which is a predetermined maximum limit of the horisontal distance between connection points, which for said load and said sling will result in said static force which may be applied to each sling leg during lifting. In this way, it is no longer necessary to measure the angle to the vertical of the sling legs. Instead, one has to check, in addition to observing the working load limit (WLL), that the maximum horisontal distance between any two connection points does not exceed the given horisontal length limit (HLL). Such a check or measurement is much easier to perform on the jobsite.

The expression “maximum limit of the horisontal distance between connection points” means that the limit is related to the greatest distance between the connection points. In a rectangular configuration (4-leg-sling), the greatest distance is along a diagonal. Moreover, for loads having a complicated or irregular geometri, it may happen that the connection points are not located exactly in the same horisontal plane.

Apart from the improved method, as defined in claim 1, the invention also concerns a lifting sling (claim 8) provided with a safety indicator, such as a tag indicating the working load limit (WLL) as well as the horisontal length limit (HLL), and such a tag (claim 10) to be attached to the associated lifting sling.

The invention will explained further below with reference to the appended drawings.

### BRIEF DESCRIPTION OF THE DRAWINGS

FIG. 1 illustrates schematically a prior art method of determining the load limit for a chain sling with two legs;

FIG. 2 illustrates schematically the method according to the present invention for determining the load limit for a chain sling corresponding to the one shown in FIG. 1;

FIGS. 3a, 3b and 3c illustrate schematically the method according to the present invention for a lifting sling with two legs, three legs and four legs, respectively;

FIGS. 4a to 4g illustrate schematically various lifting slings with a loop extending around the load (and without a load in FIG. 4g);;

FIGS. 5a to 5d illustrate schematically a two-leg lifting sling provided with markings for checking the maximum load conditions; and

FIGS. 6a, 6b, 7a, 7b, 8a and 8b show three different safety tags to be attached to associated lifting slings.

### DETAILED DESCRIPTION OF PREFERRED EMBODIMENTS

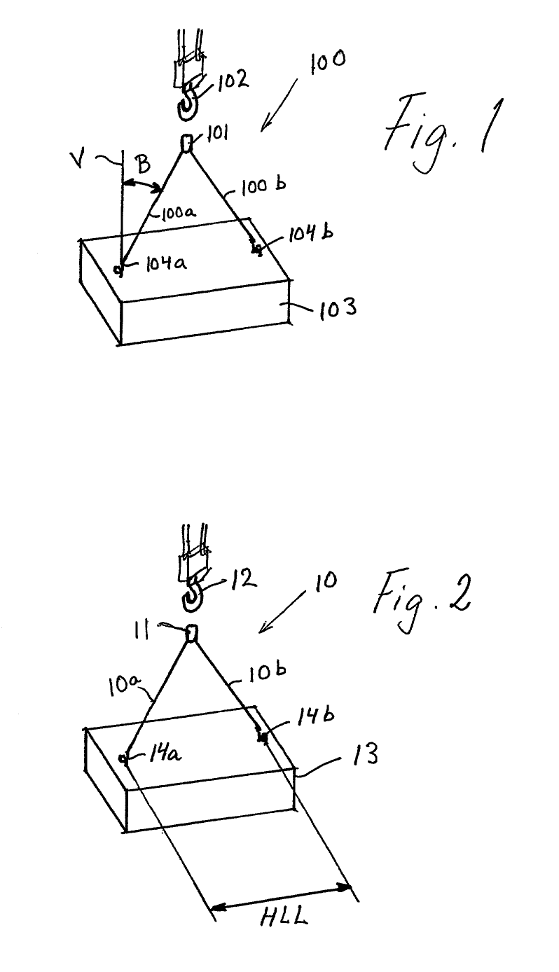

In FIG. 1 there is illustrated a two-leg chain sling 100 with two sling legs 100a and 100b, which are joined together at their top end portions and are connected to a common elongated master link 101. The latter can be hung onto a crane hook 102 of a lifting device, such as a lifting crane. At the bottom end portions, the sling legs are detachably connected to a load 103 by means of terminal attachment fittings 104a and 104b, e.g. in the form of hooks, end links or shackles.

In order to ensure that the rated maximum work load or Working Load Limit (WLL), as discussed above, is not exceeded, the user has to check, according to a prior art method, that the angle B between the respective sling leg 100a, 100b and the vertical direction V does not exceed a predetermined angle, normally 45 degrees or 60 degrees. As mentioned above, it is often quite difficult in a practical situation to measure this angle with sufficient accuracy.

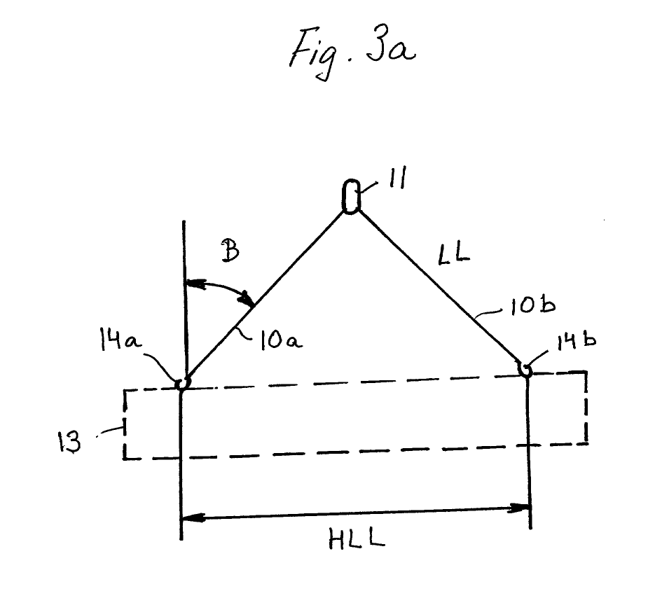

In accordance with the present invention, a different measure is taken, namely to check that the horisontal distance between the connection points at the load does not exceed a given value, the so called Horisontal Length Limit HLL, as illustrated in FIG. 2. Here, a lifting sling 10 with sling legs 10a, 10b is connected to a common master link 11 and a crane hook 12 in the same way as in FIG. 1. Likewise, the sling legs are connected to the load 13 by terminal attachment fittings 14a, 14b.

The user only has to check that the required horisontal distance between the connection points 14a, 14b, in a horisontal plane, does not exceed a predetermined value, the Horisontal Length Limit HLL. It will be appreciated that this is equivalent to the conventional criterium that the angle B (FIG. 1) does not exceed a given value, provided that the arrangement is symmetric, i.e. that the two sling legs 10a, 10b (FIG. 2) are of equal length and that the connection points 14a, 14b are located in a horisontal plane, so that the tensional load applied to each sling leg is the same.

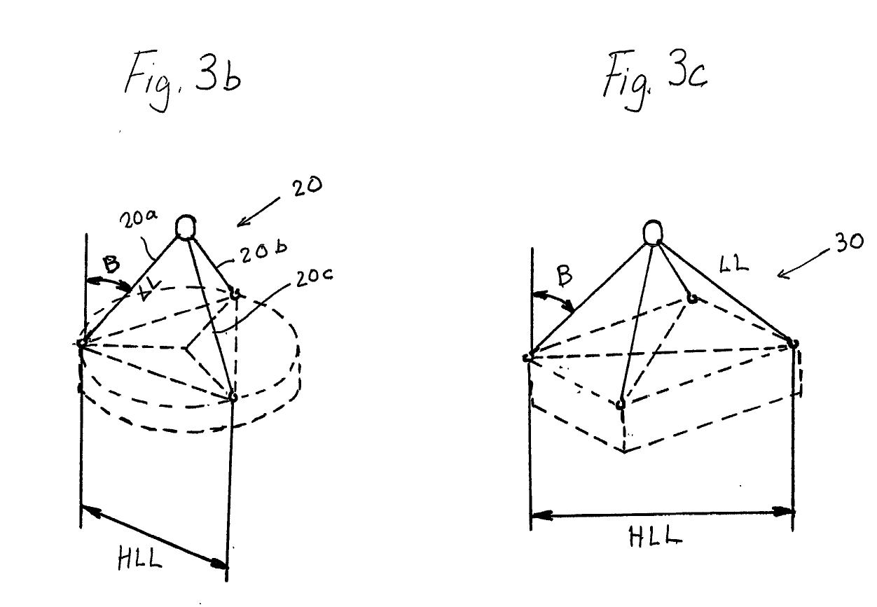

The two-leg lifting sling 10 is illustrated schematically also in FIG. 3a, in a side view. From this figure, it is apparent that the Horisontal Length Limit HLL is related to the length LL of each leg 10a, 10b as follows (not taking account of the configuration of the master link assembly):

HLL=2*LL*sin B

FIG. 3b illustrates a lifting sling 20 with three symmetrically arranged legs 20a, 20b and 20c. From the geometry it can be shown that the relation between the HLL and LL is as follows:

HLL=2*LL*sin B*cos30°

Similarly, for a lifting sling 30 with four legs (the two diagonals being of equal length), as illustrated in FIG. 3c, the relation is:

HLL=2*LL*sin B

In general, any number of sling legs may be coupled to the load at connection points located in the corners of a regular polygone in a horisontal plane.

So, with the knowledge of the leg length LL of the lifting sling, it is possible to calculate the Horisontal Length Limit HLL by means of the above equations. The HLL values each correspond to a respective maximum angle to vertical B. Therefore, as stated above, it is sufficient for the user to observe the Working Load Limit WLL and the Horisontal Length Limit HLL (instead of the limit of the angle to vertical B).

Those skilled in the art can easily calculate, by elementary geometry, corresponding equations and HLL values for other configurations, including the loop slings being discussed below.

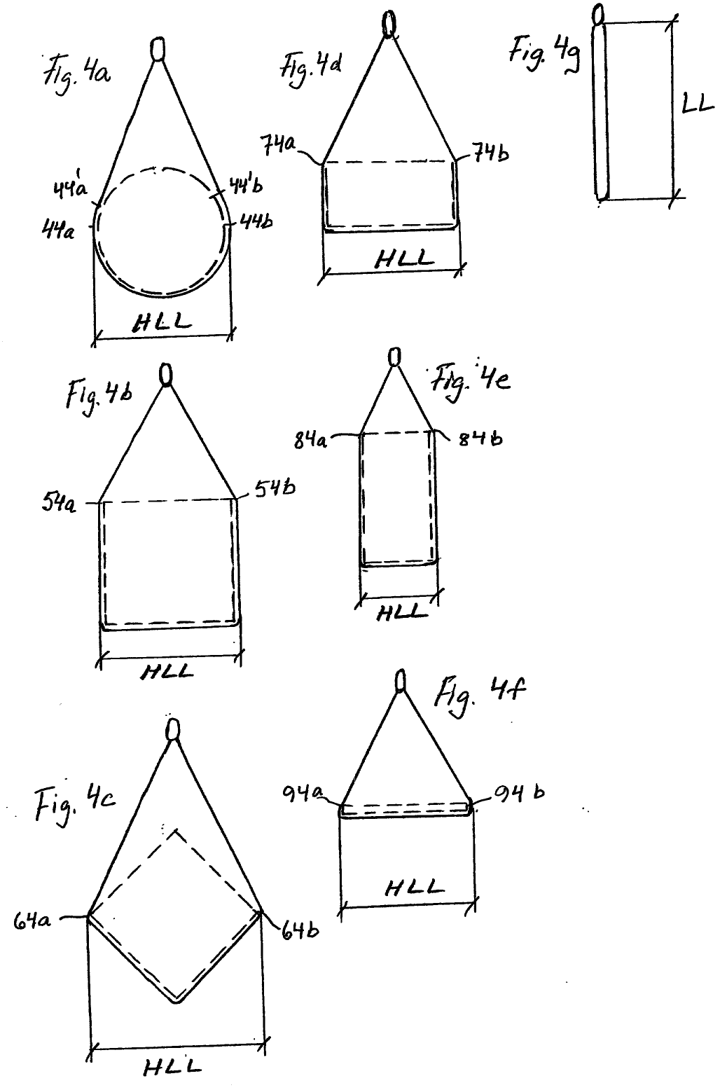

In FIGS. 4a to 4f, the corresponding Horisontal Length Limit values HLL are shown for a lifting sling in the form of a sling loop extending around and underneath the load. These loops can be single or double. The cross sectional shapes of the loads are circular (FIG. 4a), square (FIG. 4b), square diagonal (FIG. 4c), rectangular (FIG. 4d), rectangular standing (FIG. 4e), and flat linear (FIG. 4f). In all these six cases the connection points 44a, 44b, . . . , 94a, 94b are the horisontally most spread apart points where the sling loop makes effective mechanical contact with the load. The distance between these connection points is the Horisontal Length Limit HLL. In these cases, the leg length for rather the “loop length” is defined as the distance between the master link and the lower end of the loop hanging down freely, as shown in FIG. 4g.

Of course, the relations between LL and HLL will be different from the equations shown above (and somewhat more compliated).

In the case of a circular cross-section of the load, as shown in FIG. 4a, the Horisontal Length Limit HLL is defined as the circular diameter, which is easy to determine, rather than the somewhat shorter distance between the vertically highest connection points 44′a, 44′b. For practical reasons, the HLL should be easy to find out, without complicated calculations for each load.

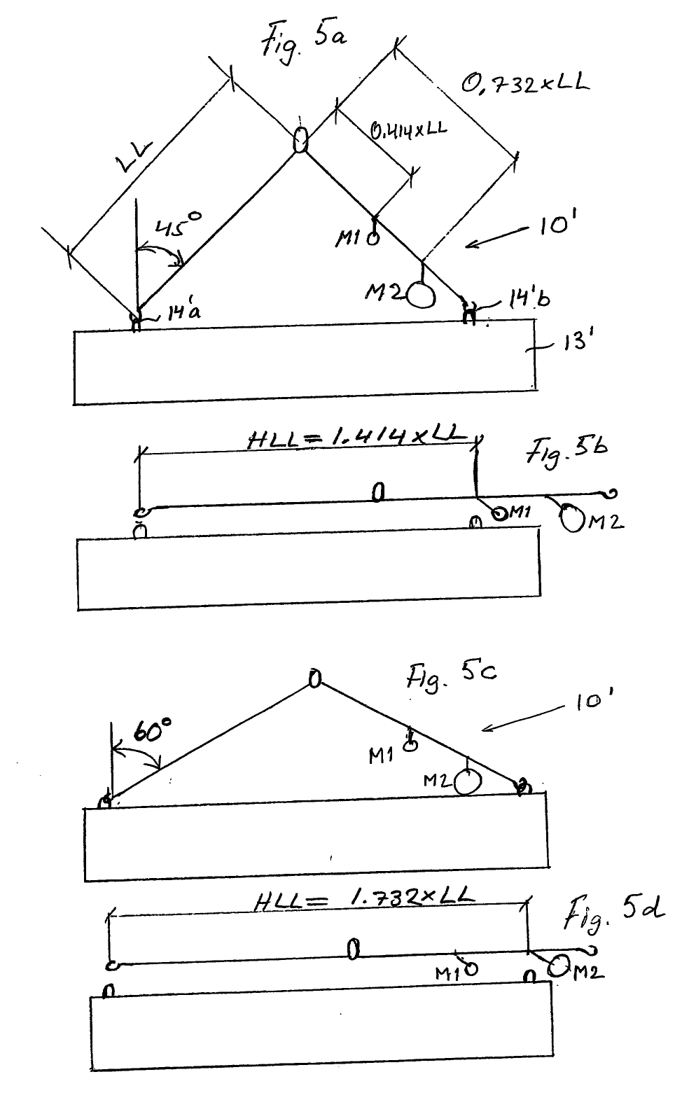

FIGS. 5a, 5b, 5c, 5d illustrate a two-leg lifting sling 10′ with two markings M1, M2, e.g. of a specific colour, at certain distances from the master link. These distances, 0.414*LL and 0.732*LL, are such that they can be used to check that the actual distance between the connection points 14′a, 14′b at the load 13′ does not exceed the Horisontal Length Limit HLL, as illustrated in FIGS. 5a, 5b (for an equivalent angle to the vertical of 45 degrees) and in FIGS. 5c, 5d (for an equivalent angle to the vertical of 60 degrees). The lifting sling is simply stretched out on the load for comparison of the sling length 1.414 LL (or 1.732 LL) and the distance between the connection points 14′a and 14′b. If the sling length is longer than said distance, it is safe to lift the load with the lifting sling.

Corresponding markings can be attached to three-leg-slings and four-leg-slings, the lengths then being 1.225 LL (at 45°) and 1.5 LL (at 60°) for a three-leg-sling and 1.414 (at 45°) and 1.732 LL (at 60°) for a four-leg-sling.

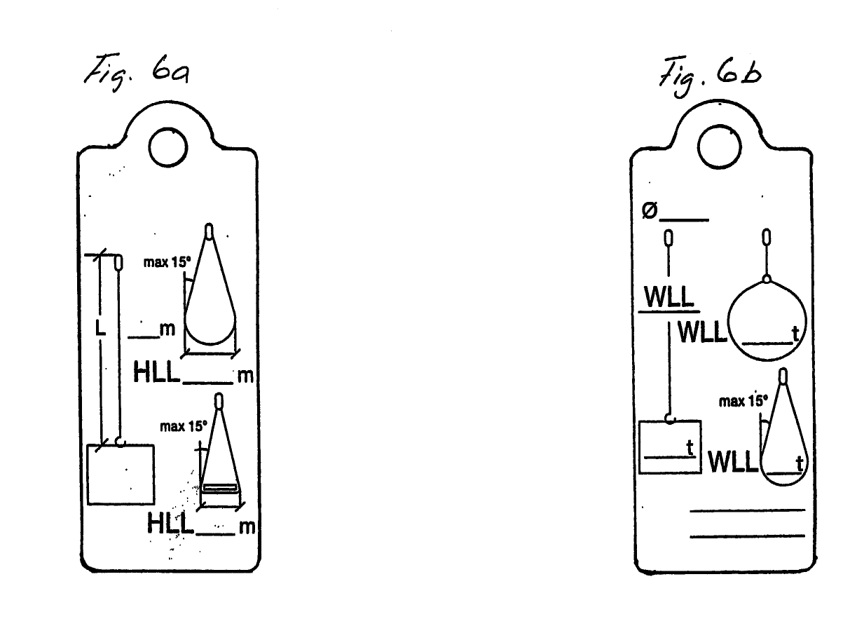

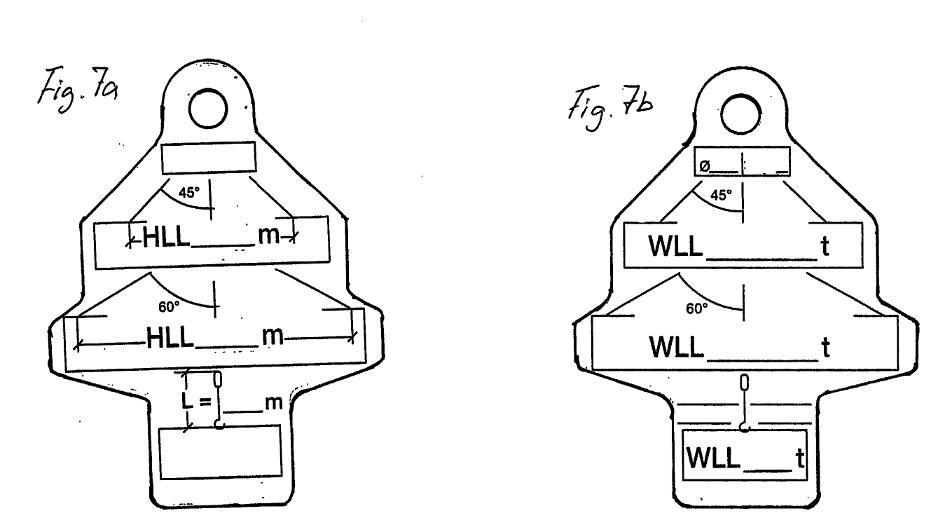

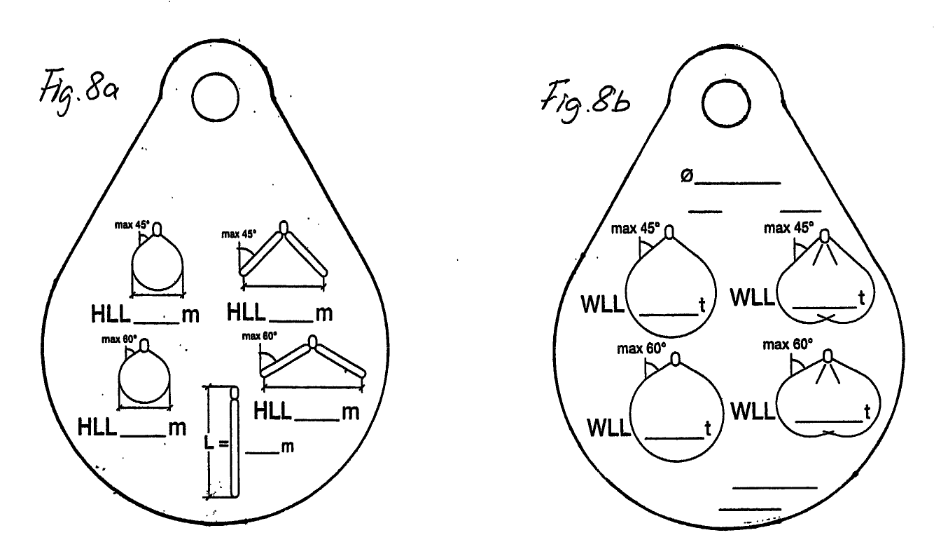

A convenient way of facilitating the safety check to the user is to attach a tag to the lifting sling. Such tags are illustrated in FIGS. 6a, 6b for a one-leg sling, in FIGS. 7a, 7b for a two-to-four-leg-sling, and in FIGS. 8a, 8b for a loop-formed sling, respectively. On one side of the tag, the Working Load Limit WLL is indicated, and on the other side of the tag, the respective Horisontal Length Limit HLL is shown, corresponding to angles to the vertical of 45 degrees and 60 degrees. If the weight of the load is lower than the WLL and the (greatest) distance between the connection points does not exceed the HLL (both values corresponding to either 45 degrees or 60 degrees), it is safe to carry out the lifting operation.

The tag can be replaced by some other indicator, e.g. a colour marking or a special pattern or the like, indicating the Work Load Limit WLL as well as the Horisontal Length Limit HLL.

In actual cases, of course, there may be loads having a very complicated geometry such that the connection points will not be well defined, e.g. if the load is not rigit but made of resilient material. Normally, however, the connection points will approach each other in such a case, and there will be no risk of sling breakage.

1. A method for providing a safety measure when lifting a load by means of a lifting sling coupled to a lifting device, said lifting sling having at least two sling legs carrying the load during lifting, said safety measure being taken in combination with observing a working load limit (WWL) corresponding to a predetermined maximum value of the static force which may be applied to each sling leg during lifting,
characterized in that said safety measure is provided by also observing a predetermined maximum limit of horisontal length limit, HLL of the horisontal distance between connection points, which for said load and said sling will result in said static force which may be applied to each sling leg during lifting.

2. A method as defined in claim 1, wherein said lifting sling comprises two sling legs being connected to the load at connection points located at opposite ends of a straight line in said horisontal plane.

3. A method as defined in claim 1, wherein said lifting sling comprises at least three sling legs being connected to the load at connection points located at the corners of a regular polygone in said horisontal plane.

4. A method as defined in claim 1, wherein said lifting sling comprises at least two sling legs to be connected to the load at sling leg end portions provided with terminal attachment fittings, said fittings being located at said connection points.

5. A method as defined in claim 1, wherein said lifting sling comprises a loop which is positionable so as to extend around and underneath the load during lifting, said connection points for said loop being the two horisontally most spread apart points where the loop makes effective mechanical contact with the load during lifting.

6. A method as defined in claim 1, wherein a safety indicator, indicating said horisontal length limit (HLL) and said working load limit (WLL), is attached to said lifting sling.

7. A method as defined in claim 1, wherein at least one of said sling legs is provided with a marking at a predetermined position enabling a check, by stretching the sling legs into a rectilinear configuration before lifting, that the largest distance between said connection points does not exceed said horisontal length limit (HLL).

8. A lifting sling for coupling to a lifting device, said lifting sling comprising at least two sling legs for carrying a load during lifting, characterized by an associated safety indicator indicating a predetermined maximum limit (Horisontal Length Limit HLL) of the horisontal distance between connection points, which for said load and said sling will result in a predetermined static force which may be applied to each sling leg during lifting.

9. A lifting sling as defined in claim 8, wherein said associated safety indicator comprises a safety tag being attached to said lifting sling.

10. A safety tag as defined in claim 9, indicating the working load limit (WLL) as well as said horisontal length limit (HLL).
